(19) United States
(12) Patent Application Publication
(10) Pub. No.: US 2004/0267451 A1
(43) Pub. Date: Dec. 30, 2004

(54) LBS having GPS receiver and operating method thereof

(75) Inventors: Ki Yong Park, Taebaek-si (KR); Il Soo Cho, Seoul (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/875,754

(22) Filed: Jun. 23, 2004

(30) Foreign Application Priority Data
Jun. 27, 2003 (KR) 42806/2003

(51) Int. Cl. G01C 21/26

(52) U.S. Cl. 701/213; 342/357.06

(57) ABSTRACT

Provided is a method of operating an LBS having a GPS receiver, the method including: determining whether a power of a moving body provided with the GPS receiver is turned off while a power is supplied and a location-based on service is provided; transmitting a power supply stop signal to the GPS receiver, when a power off of the moving body is sensed; storing a GPS backup information at the GPS receiver; and stopping the power supply to the GPS receiver and then supplying a backup power, when a storage completion information of the GPS backup information is received from the GPS receiver.

### CROSS-REFERENCE TO RELATED APPLICATIONS

Pursuant to 35 U.S.C. § 119(a), this application claims the benefit of earlier filing date and right of priority to Korean Application No. 2003-42806, filed on Jun. 27, 2003, the contents of which is hereby incorporated by reference herein in their entirety.

### BACKGROUND OF THE INVENTION

1. Field of the Invention

The present invention relates to an LBS having a GPS receiver and operation method thereof.

2. Description of the Related Art

A location-based on service system (LBS) on development is basically provided with a global positioning system (GPS) receiver to compute an absolute position information. The GPS receiver is built in a mobile station or a car navigation system, and the LBS is gradually widening its service area using position information of a mobile body.

For instance, the car navigation system is configured to include a function to obtain position of a vehicle on occasion and inform a user of the obtained position information. To realize the above function, the car navigation system is provided with a GPS receiver.

The GPS receiver receives GPS satellite information through a GPS antenna when a power is supplied, and catches the position of a mobile body using the received GPS satellite information.

However, in case the GPS receiver is integrated and used with the LBS, when a supply power is changed, the GPS receiver abnormally operates. The abnormal operation of the GPS receiver lowers a basic performance of the GPS receiver and decreases accuracy of the position information.

In the above, the abnormal operation represents that main functions such as excessive GPS position tracing time, failure of continuous position tracing on position tracing and normal operation, etc., of the GPS receiver are not exactly performed.

### SUMMARY OF THE INVENTION

Accordingly, the present invention is directed to an LBS having a GPS receiver and operation method thereof that substantially obviates one or more problems due to limitations and disadvantages of the related art.

A first object of the present invention is to provide an LBS having a GPS receiver and operation method thereof that enables the GPS receiver to normally perform its performances without being affected by a change in a supply power although the supply power is changed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of operating an LBS having a GPS receiver, the method including: determining whether a power of a moving body provided with the GPS receiver is turned off while a power is supplied and a location-based on service is provided; transmitting a power supply stop signal to the GPS receiver, when a power off of the moving body is sensed; storing a GPS backup information at the GPS receiver; and stopping the power supply to the GPS receiver and then supplying a backup power, when a storage completion information of the GPS backup information is received from the GPS receiver.

In an aspect of the present invention, there is provided an LBS having a GPS receiver, comprising: the GPS receiver receiving a GPS satellite signal and providing a GPS satellite information and when a power supply stop signal is received from the LBS, storing a GPS backup information; a sensor for computing a traveling distance information and an advancing direction information of a moving body provided with the GPS receiver; a CPU for when a power off of the moving body is sensed while creating and providing a navigation information necessary for a location-based on service using the GPS satellite information transmitted from the GPS receiver and the traveling distance information and the advancing direction information computed by the sensor, transmitting the power supply stop signal to the GPS receiver, and when a signal informing that a storage of the GPS backup information has been completed is received, stopping a power supply to the LBS and supplying a backup power to the GPS receiver; a power unit for supplying a power to the moving body; a power controller for controlling a power supply to the power unit; and a memory for storing the GPS backup information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an LBS having a GPS receiver according to the present invention;

FIG. 2 is a flow diagram illustrating a method of operating an LBS having a GPS receiver according to the present invention; and

FIG. 3 is a flow diagram illustrating a signal transmission between a GPS receiver and a CPU in an LBS having the GPS receiver according to the present invention.

### DETAILED DESCRIPTION OF THE INVENTION

Reference will now be made in detail to the preferred embodiments of the present invention, examples of which are illustrated in the accompanying drawings.

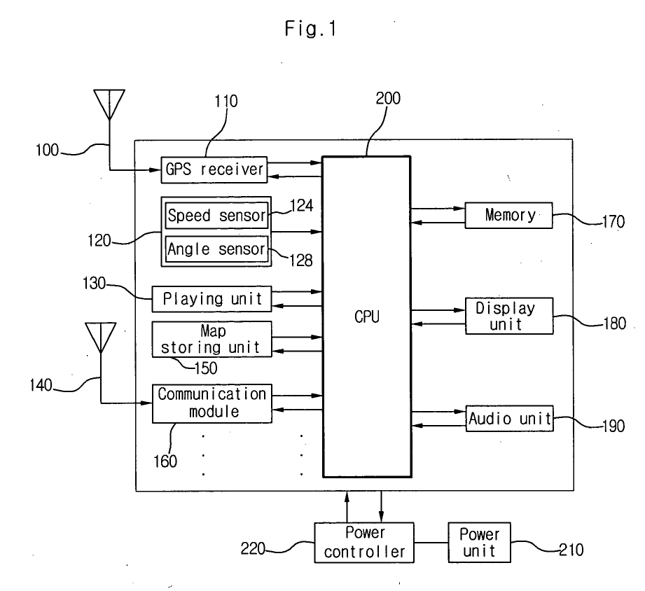

FIG. 1 is a block diagram of an LBS having a GPS receiver according to the present invention.

Referring to FIG. 1, the LBS includes a GPS antenna 100 for receiving a GPS satellite signal, a GPS receiver 110 for outputting a GPS satellite information including a latitude, a longitude and a time information, and a sensor 120 for computing a traveling distance information and an advancing direction information of a moving body. Also, the LBS further includes a playing unit 130 for playing a DVD or a CD, a communication antenna 140 enabling the LBS to communicate with a central control center or a base station, and a map storing unit 150 for storing a navigation map data. Further, the LBS includes a communication module 160 having an interface enabling data receipt and transmission with the base station, a memory 170 for temporarily storing computation data, a display unit 180 for displaying a processing result, and an audio unit 190 enabling reproduction of FM/AM/Tape and playing a processing result as a sound. Moreover, the LBS includes a central processing unit 200 for controlling all the units of the LBS, a power unit 210 for supplying a power to the LBS, and a power controller 220 for controlling a power supply.

The GPS receiver 110 receives a GPS satellite signal from the GPS antenna 100 and outputs GPS satellite information including a coordinate data consisting of a longitude, a latitude and a height, and an absolute transmission time.

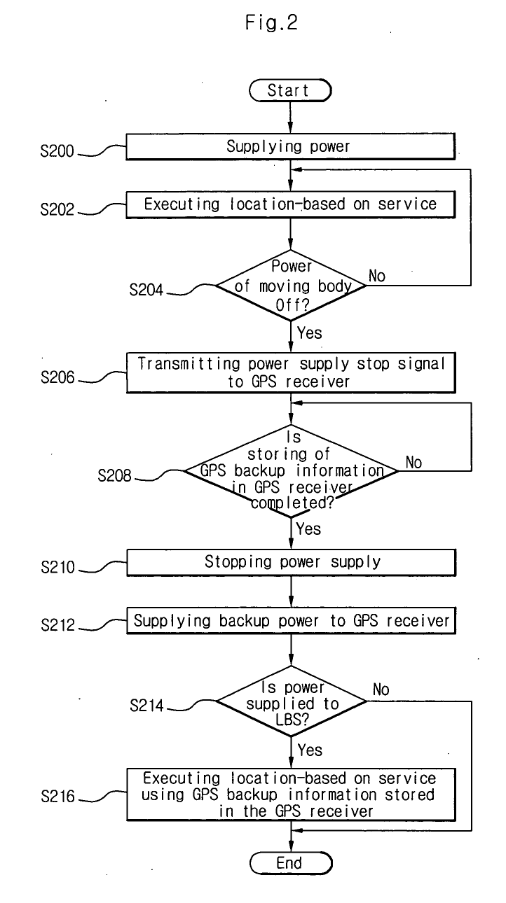

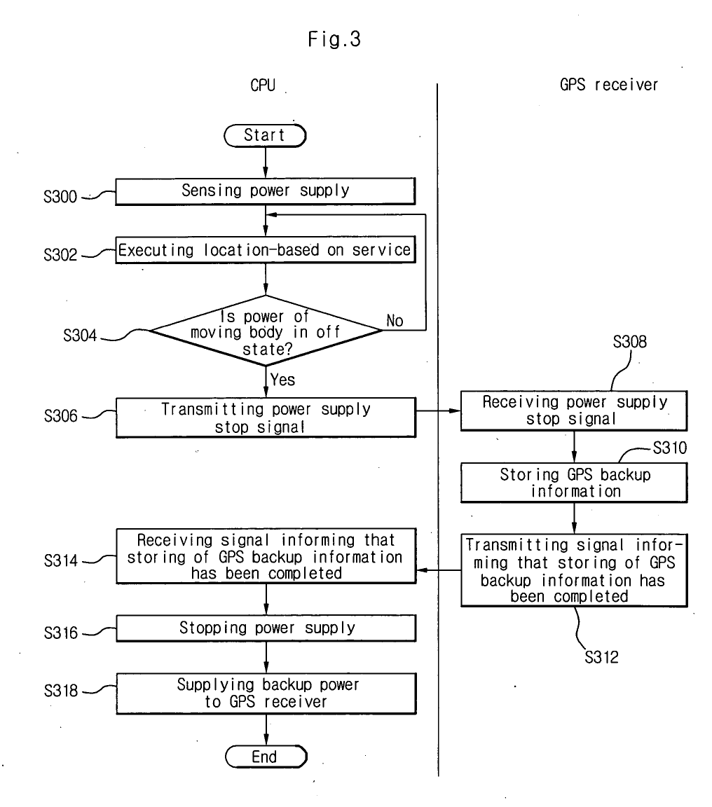

Also, the GPS receiver 110 stores a GPS backup information when a power supply stop signal is received from the CPU 200. The GPS backup information indicates a position estimate data, a path data with respect to a satellite, a navigation information and the like. At this time, the GPS receiver 110 stores the GPS backup information in a volatile memory such as a static random access memory (SRAM). An operation of the GPS receiver 110 will be described later in more detail with reference to FIGS. 2 and 3.

The sensor 120 includes a speed sensor 125 for computing a traveling distance information of the moving body and an angle sensor 128 for computing a traveling direction information of the moving body. The map storing unit 150 stores a map display data, a path guide data, a facility list data and the like.

The CPU 200 creates all navigation information necessary for the location-based on service, such as a current position of the moving body, a speed information, an angle information and the like by combining the GPS satellite information transmitted from the GPS receiver 110 with the information of the speed sensor 124 and the angle sensor 128.

Also, the CPU 200 transmits a power supply stop signal to the GPS receiver 110 when it is sensed that the power of the moving body is turned off. The power supply stop signal is indicative of a signal informing that the power supply to the LBS is stopped.

After transmitting the power supply stop signal, the CPU 200 completely cuts off the power supply to the LBS and supplies the backup power to the GPS receiver 110. The backup power is supplied to allow the GPS receiver 110 to store the backup information until the system power is again supplied to the GPS receiver 110 because the GPS receiver 110 stores the GPS backup information in a volatile memory.

The operation of the LBS constructed as above will now be described.

As power is supplied to the LBS from the power unit 210, the CPU 200 senses the power supply and executes the location-based on service. In other words, after the CPU 200 receives the GPS satellite information from the GPS receiver 110, it combines the received GPS satellite information with the information of the speed sensor 124 and the angle sensor 128, thereby creating a position, speed, angle and the like of the current moving body.

Thereafter, the CPU 200 displays the created navigation information on the display unit 180.

When it is sensed that power of the moving body is turned off during the above operation, the CPU 200 generates and transmits a power supply stop signal to the GPS receiver 110. Then, the GPS receiver 110 stores the GPS backup information and then transmits to the CPU a signal informing that a storing of the GPS backup information has been completed. Herein, the GPS receiver 110 stores the GPS backup information in the volatile memory such as an SRAM.

Then, the CPU 200 stops the power supply through the power controller 220, and supplies a backup power to the GPS receiver 110 so as to store the GPS backup information stored in the GPS receiver 110 until the power is again supplied. Hence, the GPS receiver 110 can continue to store the backup information using the backup power.

Next, an operating method of the LBS having the GPS receiver when a supply power is changed will be described in more detail with reference to FIG. 2. FIG. 2 is a flow diagram illustrating a method of operating an LBS having a GPS receiver according to the present invention.

Referring to FIG. 2, when power of the moving body is turned on and thereby power is supplied to the LBS (S200), the LBS executes the location-based on service (S202). The moving body may be a vehicle, a mobile station (handheld phone, PDA or the like).

After that, the LBS determines whether the power of the moving body is turned off (S204). In other words, when the moving body is a vehicle, the LBS determines whether a start power is in off state, and when the moving body is a mobile station, the LBS determines whether a terminal power is in off state.

As a result of determination of the step S204, when it is determined that the power of the moving body is turned off, the LBS transmits the power supply stop signal to the GPS receiver 110 (S206). Then, the GPS receiver 110 performs the step of storing the GPS backup information. The GPS backup information is indicative of the position estimate data, the path data with respect to a satellite, the navigation information and the like, and can be stored in the volatile memory.

After the step S206, the LBS determines whether the GPS receiver 110 completes the storing of the GPS backup information (S208). In other words, the LBS determines whether the signal informing that the storing of the GPS backup information is completed is received.

As a result of the step S208, when it is determined that the GPS receiver 110 completes the storing of the GPS backup information, the LBS stops the power supply (S210) and supplies the backup power to the GPS receiver 110 (S212). The GPS receiver 110 can store the GPS backup information using the backup power until power is again supplied to the LBS.

After the step S212, the LBS determines whether power is again supplied to the LBS as power of the moving body is turned on (S214).

In the step S214, it is determined that power is again supplied to the LBS, the LBS performs the location-based on service using the GPS backup information stored in the GPS receiver 110 (S216).

Meanwhile, FIG. 3 is a flow diagram illustrating a signal transmission between a GPS receiver and a CPU in an LBS having the GPS receiver according to the present invention.

Referring to FIG. 3, the CPU 200 executes the location-based on service (S302) when the power of the moving body is turned on and thereby it is sensed that power is supplied to the LBS (S300).

Then, the CPU 200 determines whether the power of the moving body is turned off (S304).

In the step S304, when it is determined that the power of the moving body is turned off, the CPU 200 generates and transmits the power supply stop signal to the GPS receiver (S306).

Then, the GPS receiver 110 receives the power supply stop signal transmitted from the CPU 200 (S308) and stores the GPS backup information (S310).

Next, the GPS receiver 110 transmits to the CPU 200 the signal informing that the storing of the GPS backup information has been completed (S312).

Then, the CPU 200 receives the signal informing that the storing of the GPS backup information has been completed from the GPS receiver 110 (S314) and stops the power supply to the LBS (S316).

Next, the CPU 200 supplies the backup power to the GPS receiver 110 (S318).

The GPS receiver 110 can maintain the stored GPS backup information by the backup power supplied from the CPU 200.

When a user turns on the power of the moving body to use the LBS, the GPS backup information safely stored can be used, thereby capable of normally tracing the position of the moving body and enhancing the performance of the LBS.

As described above, according to the present invention, although a supply power is changed, the GPS receiver is prevented from being abnormally operated, thereby maintaining the performance of the GPS receiver and maximizing the quality of the LBS.

Also, the present invention can be applied to a charge battery power of a mobile station or a GPS receiver using a general battery power as well as a battery power for a vehicle in which supply power is heavily varied.

Further, according to the present invention, the performance of the GPS receiver can be simply realized only by using a software, so that it becomes possible to operate the GPS receiver stably and more economically.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of operating an LBS having a GPS receiver, the method comprising:
determining whether a power of a moving body provided with the GPS receiver is turned off while a power is supplied and a location-based on service is provided;
transmitting a power supply stop signal to the GPS receiver, when a power off of the moving body is sensed;
storing a GPS backup information at the GPS receiver; and
stopping the power supply to the GPS receiver and then supplying a backup power, when a storage completion information of the GPS backup information is received from the GPS receiver.

2. The method of claim 1, when a power of the moving body is again turned on, again providing the location-based on service of the moving body using the GPS backup information stored in the GPS receiver.

3. The method of claim 1, wherein the GPS backup information comprises a position estimate data, a path data with respect to a satellite, and a navigation information.

4. The method of claim 1, wherein the GPS backup information is stored in a volatile memory.

5. The method of claim 1, wherein the GPS backup information is stored in an SRAM.

6. The method of claim 1, wherein the backup power enables the GPS backup information stored in the GPS receiver to be maintained until the power is again supplied to the moving body.

7. The method of claim 1, wherein the moving body is a vehicle.

8. The method of claim 1, wherein the moving body is a mobile station.

9. An LBS having a GPS receiver, comprising:
the GPS receiver receiving a GPS satellite signal and providing a GPS satellite information and when a power supply stop signal is received from the LBS, storing a GPS backup information;
a sensor for computing a traveling distance information and an advancing direction information of a moving body provided with the GPS receiver;
a CPU for when a power off of the moving body is sensed while creating and providing a navigation information necessary for a location-based on service using the GPS satellite information transmitted from the GPS receiver and the traveling distance information and the advancing direction information computed by the sensor, transmitting the power supply stop signal to the GPS receiver, and when a signal informing that a storage of the GPS backup information has been completed is received, stopping a power supply to the LBS and supplying a backup power to the GPS receiver;
a power unit for supplying a power to the moving body;
a power controller for controlling a power supply to the power unit; and
a memory for storing the GPS backup information.

10. The LBS of claim 9, wherein the GPS satellite information comprises a coordinate data consisting of a longitude, a latitude, and a height, and an absolute transmission time.

11. The LBS of claim 9, wherein the GPS backup information comprises a position estimate data, a path data with respect to a satellite, and a navigation information.

12. The LBS of claim 9, wherein the memory is a volatile memory.

13. The LBS of claim 9, wherein the memory is an SRAM.

14. The LBS of claim 9, wherein the backup power supplied to the GPS receiver enables the GPS backup information stored in the GPS receiver to be maintained until the power is again supplied to the moving body.

15. The LBS of claim 9, wherein the moving body is a vehicle.

16. The LBS of claim 9, wherein the moving body is a mobile station.
